(19) United States
(12) Patent Application Publication
(10) Pub. No.: US 2012/0101928 A1
(43) Pub. Date: Apr. 26, 2012

(54) DEBT RECOVERY ADMINISTRATION AND PORTFOLIO MANAGEMENT SYSTEM

(75) Inventors: Christopher J. Fry, Houston, TX (US); Robert B. Hoppel, Houston, TX (US); Jeff M. Moloch, Houston, TX (US)

(73) Assignee: CJR DEVELOPMENT, INC., Houston, TX (US)

(21) Appl. No.: 13/086,170

(22) Filed: Apr. 13, 2011

Related U.S. Application Data
(60) Provisional application No. 61/323,487, filed on Apr. 13, 2010.

(51) Int. Cl. G06Q 40/00

(52) U.S. Cl. 705/35

(57) ABSTRACT

A system and method for the automation of debt recovery relating to deficiencies in amounts owed for a vehicle includes a database; an input translation module to receive a plurality of accounts; a judgment module enabled to receive user input and store data relating to a court judgment; modules for garnishment, tracking, queuing, output translation, and other actions enabled to use the data set to batch calculate and produce filing information and documentation required to initiate and maintain garnishments, judgments, tracking accounts through metatags and associated safeguards, display, index, and navigate a subset of accounts based on selected attributes of the data set, and transform the data set for use by accounting and financial analysis systems.

### CROSS-REFERENCE TO RELATED APPLICATIONS

This application is a non-provisional of U.S. Provisional Patent Application 61/323,487, filed Apr. 13, 2010, and titled Debt Collection Software for the High Risk Auto Industry Interfaced with a Database Backend Allowing for Document Preparation and Data Storage, which is herein entirely incorporated by reference.

### FIELD OF THE INVENTION

The present disclosure relates to vehicle loans which have fallen into default, and, more particularly, to a system and a method for the automation of the collection of bad debts relating to same.

### BACKGROUND

It is estimated that there are over 20,000 automobile dealers in the United States alone. Within this sizeable marketplace, car purchases most often take place in connection with some sort of financing deal, for example a loan. Sales of other vehicles, for example motorcycles, boats, and aircraft also very frequently entail a financing arrangement.

An increasing segment of this business is made up of dealers who, at least initially, finance the vehicle sale transactions taking place on their lots, including the significant number of dealers who participate in the National Alliance of Buy-Here, Pay-Here Dealers trade group. These automobile dealers in particular often encounter and contract with the subprime buyer market.

Unfortunately, even in the best of economic times, a certain number of vehicle loans will not be timely paid, and the balances thereon will fall into deficiency. Pursuit of such deficiency balances can be a challenge for any creditor, but typically proves very difficult for a self-financing vehicle dealership. In the prior art, the tracking of any court judgment details was laborious and time-intensive, whether done by hand or with the aid of standalone spreadsheet software, for even a small amount of collection accounts. To make matters even more demanding, means for collecting a judgment on an amount owed, for example garnishment of a creditor's wages or a tax refund, may expire and thus need to be closely monitored and possibly re-filed.

The concept of a debt collection system involving software is not new. However, such database management systems do not provide the necessary modules and methods to efficiently pursue bad debts in gross. Prior systems also do not even have the ability to track the debt collection process past the point of repossession of the vehicle.

### SUMMARY

The present invention may comprise one or more of the following features and combinations thereof.

A system for vehicle account collection, including: a database for storing a data structure; an input translation module enabled to receive and transform for storage in the data structure a data set including a plurality of accounts, each account describing a vehicle, a first and second party, and an amount owed by the first party to the second party in regard to the vehicle; a judgment module enabled to receive user input and store in the data set data relating to obtaining and results of a court judgment regarding the amount owed; a tax garnishment module enabled to use the data set to calculate and produce filing information and documentation required to initiate and maintain various states' income tax garnishment from the first party; a wage garnishment module enabled to use the data set to calculate and produce filing information and documentation required to initiate and maintain wage garnishment from the first party; a tracking module providing a plurality of metatags and a plurality of safeguards and enabling selectively association of the plurality of metatags with each of the plurality of accounts, each metatag assigned one of the associated plurality of safeguards and describing an attribute of an account, selective ones of the plurality of safeguards providing warnings or preventing selected actions for the account for which the metatag and safeguard is associated; an action module providing a plurality of actions and associated results and enabling selectively associating the plurality of actions and associated results with each of the plurality of accounts, and enabling subsets of the accounts selected based on the associated plurality of actions and associated results; a queuing module allowing display and indexing through a subset of the plurality of accounts selected based on selected attributes of the data set; and an output translation module enable to transform the data set for use by financial accounting and/or analysis systems.

A method for vehicle account collection, comprising the steps of: building a database capable of storing a data structure; receiving and transforming for storage in the data structure a data set including a plurality of accounts, each account describing a vehicle, a first and second party, and an amount owed by the first party to the second party in regard to the vehicle; receiving user input and storing in the data set data relating to obtaining and results of a court judgment regarding the amount owed; calculating and generating filing information and documentation required to initiate and maintain various states' income tax garnishment from the first party; calculating and generating filing information and documentation required to initiate and maintain wage garnishment from the first party; selectively tagging any of the plurality of accounts from among a plurality of metatags and a plurality of safeguards, with each metatag assigned one of the associated plurality of safeguards and describing an attribute of an account; selectively enabling any of the plurality of accounts from among a plurality of actions and associated results, thereby producing subsets of the accounts selected based on the plurality of actions and associated results; queuing for display and indexing a subset of the plurality of accounts selected based on selected attributes of the data set; and transforming and outputting the data set for use by a financial accounting and analysis systems.

The system and method disclosed herein includes hardware and software to assist automobile dealers or service providers who do their own financing, including that relating to high credit risk customers. The present invention provides the user with capabilities for the automated generation of garnishment-oriented documents, including those for state income tax return garnishment, and the assessing of fees and further provides the ability to track judgment, court, bankruptcy, and other related information. Uniquely, the invention also has an “ear-marking” system involving metatags; the metatags allow a user to mark an account with a code, five characters in one embodiment, that can later be used in reporting, portfolio separation, or a number of other areas relating to account management. The reporting area of the system and method advantageously allows for an automated approach to generating garnishment writs for a selected date range and, while each document is generated, a collection note may be made and fees (as allowed by state laws) may be assessed to the account all in one process.

The system and method are table-driven, following the relational database schema, which allows quick processing and avoids manual entry of ways in which the data relate. Data can be imported in or manually entered in by the user.

Particularly, in one illustrative embodiment, the invention and its modules are categorized into eight (8) modules styled as follows for ease of display on a computer monitor and user reference: origination, judgment, bankruptcy, garnishment, collections, payments, reports, and utilities. “Modules,” as used herein, may include specific software, hardware, or both, that implement the particular concepts. Each module can be restricted based upon security settings of each user. The origination module provides a snapshot of the account before becoming a judgment. The judgment module provides all the pertinent court dates and balances and other judgment information. The bankruptcy module provides all related information, for example reaffirmation dates and collection plans as well as the bankruptcy type. The garnishment module provides all garnishment filing history including filing and expiration dates. The collections module provides means for inputting and storing all collector comments. The payments module enables the receipt of and accounting for payments or any other monies in the system, including ACH transactions. The reports module provides several ways to extract data from the system. Finally, the utilities module is a general module allowing for table and drop-down menus to be modified by the user according to his or her particular needs.

A local personal computer (PC)-based system may be used to practice the present invention, but, alternatives include specialized equipment having a processor or a Web-based version of the system allowing for platform independence, easier installation, and centralized data hosting. The latter version is compatible with the increasingly-popular Software as a Service (SaaS) model. Such platform-independent systems may include access to the Internet or other wide-area electronic network connection; firewalls; computers or other programmed processors at network nodes; a Web site-hosting computer or other processor; and an interactive Web site.

Although an illustrative embodiment is configured for the collection of debts relating to automobile loans, it is envisioned that other embodiments may be directed to the collection of debts on any sort of tangible or non-tangible objects.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a schematic block diagram of a first illustrative embodiment for implementing a system for the automation of the collection of bad debts relating to vehicle loans.

FIG. 2 is a flowchart representing some of the steps of a first illustrative embodiment of a method for the automation of the collection of bad debts relating to vehicle loans.

FIGS. 3a, 3b, 3c, 3d, 3e, 3f, 3g, 3h, 3i, and 3j are computer screen images associated with an input translation module of the system shown in FIG. 1 and relating to a data set-receiving step of the method shown in FIG. 2;

FIG. 4 is a computer screen image associated with a judgment module of the system shown in FIG. 1 and relating to a judgment data input step of the method shown in FIG. 2;

FIGS. 5a, 5b, and 5c are computer screen images associated with a tracking module of the system shown in FIG. 1 and relating to a selective tagging step of the method shown in FIG. 2;

FIGS. 6a, 6b, 6c, 6d, and 6e are computer screen images associated with a queuing module of the system shown in FIG. 1 and relating to a queuing step of the method shown in FIG. 2;

FIGS. 7a, 7b, 7c, 7d, 7e, and 7f are computer screen images associated with a garnishment module of the system shown in FIG. 1 and relating to a garnishment step of the method shown in FIG. 2;

FIGS. 8a and 8b are computer screen images associated with an action module of the system shown in FIG. 1; and

FIGS. 9a and 9b are computer screen images associated with a login requirement for access to the system shown in FIG. 1.

### DESCRIPTION OF THE ILLUSTRATIVE EMBODIMENT

For the purposes of promoting and understanding the principals of the invention, reference will now be made to one or more embodiments illustrated in the drawings and specific language will be used to describe the same.

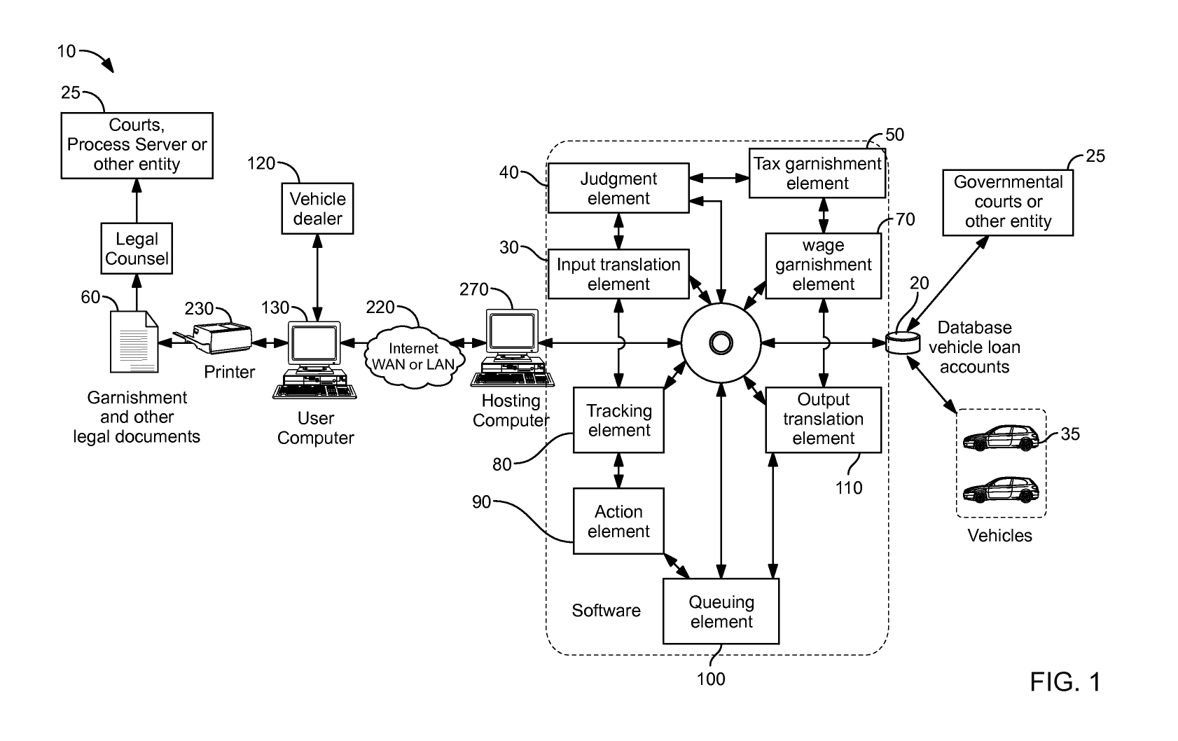

Referring to FIG. 1, an illustrative embodiment of a system 10 is shown, specifically as a network diagram of a system for automation of the collection of bad debts relating to vehicle loans. The system 10 includes: a database 20 for storing a data structure; an input translation module 30 structured to receive, extract, and transform for storage in the data structure a data set including a portfolio of accounts, each account relating to a vehicle 35, a first and second party, and an amount owed by the first party to the second party in regard to the vehicle 35; a judgment module 40 structured to receive user input and store in the data set data relating to obtaining and results of a court 25 judgment regarding the amount owed; a tax garnishment module 50 structured to use the data set to calculate and produce the filing information and documentation 60 required to initiate and maintain various states' income tax garnishment from the first party; a wage garnishment module 70 structured to use the data set to calculate and produce the filing information and documentation 60 required to initiate and maintain wage garnishment from the first party; a tracking module 80 including a plurality of metatags and a plurality of safeguards and enabling selectively associating the plurality of metatags with each of the plurality of accounts, each metatag assigned one of the associated plurality of safeguards and describing an attribute of an account, selective ones of the plurality of safeguards providing warnings or preventing selected actions for the account for which the metatag and safeguard is associated; an action module 90 providing a plurality of actions and associated results and enabling selectively associating the plurality of actions and associated results with each of the plurality of accounts, and enabling subsets of the accounts selected based on the associated plurality of actions and associated results; a queuing module 100 structured to display and index a subset of the plurality of accounts selected based on selected attributes of the data set; and an output translation module 110 structured to transform and out a portion or all of the data set for use by financial accounting and analysis systems, or other systems.

The system 10 is table-driven, following the relational database schema, which allows quick processing and avoids repetitive manual entry of ways in which the data relate. The database 20 thus matches data by using common characteristics found within the data set. Further, the various modules of the system 10 interrelate to allow an efficient, automated mode of operation.

The input translation module 30, which may be styled as an origination module, provides for the genesis of the system 10, with the goal being population of the database 20 with information concerning a plurality of vehicle 35 loan accounts before they become judgments. This information includes, but is not limited to, that about subject vehicles 35, first and second parties, and the amounts owed by first parties to second parties in regard to those vehicles 35. External repositories of information, for example a database associated with dealer-financed software, the actual vehicle loan contract, and other disposition documents are possible sources of this information.

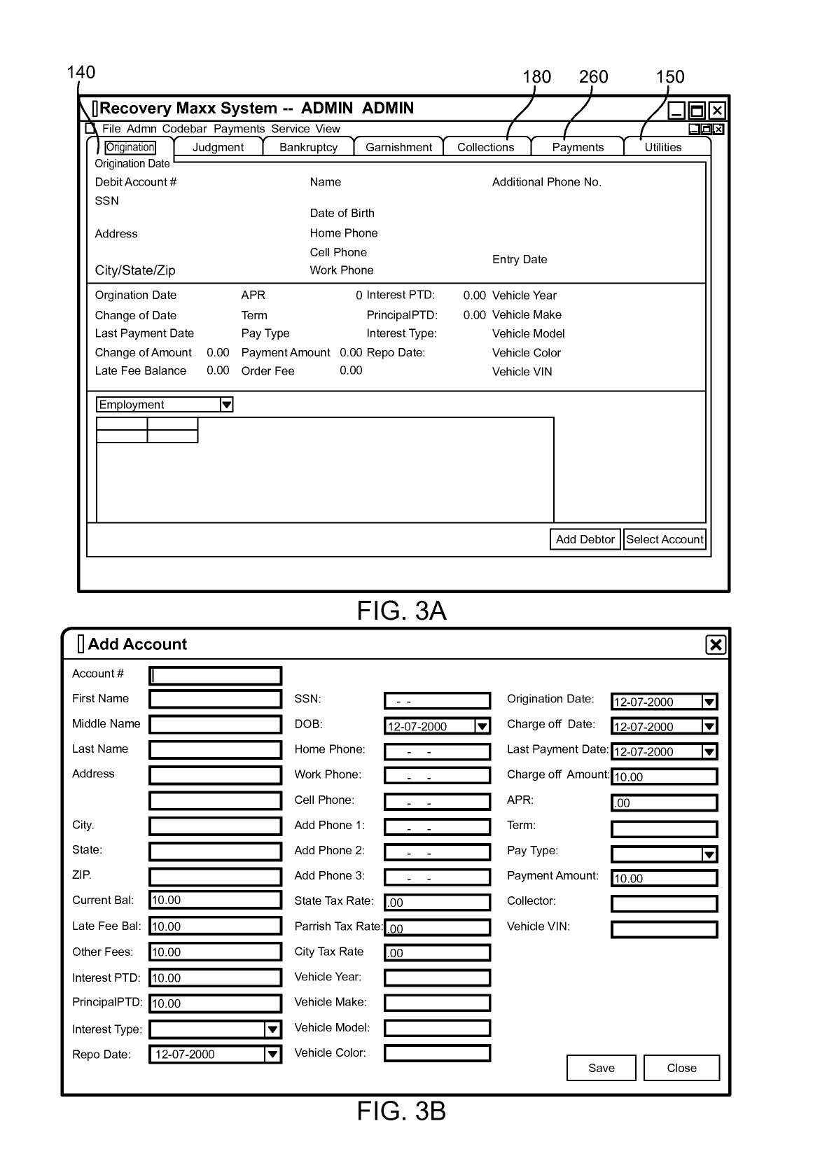

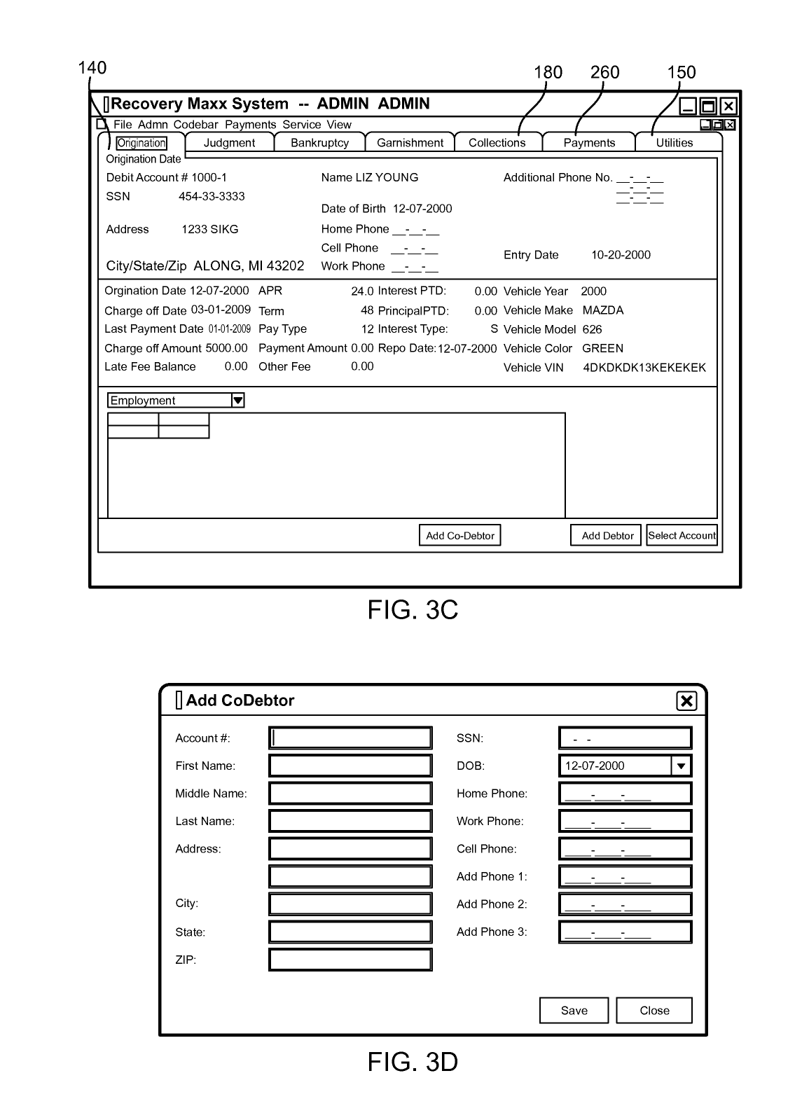

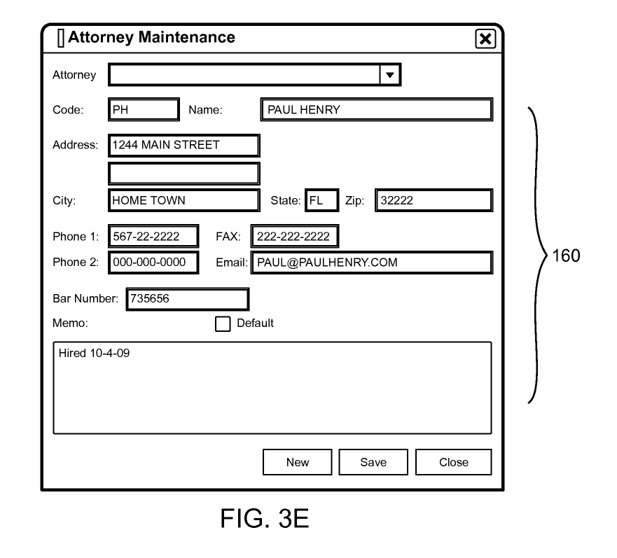

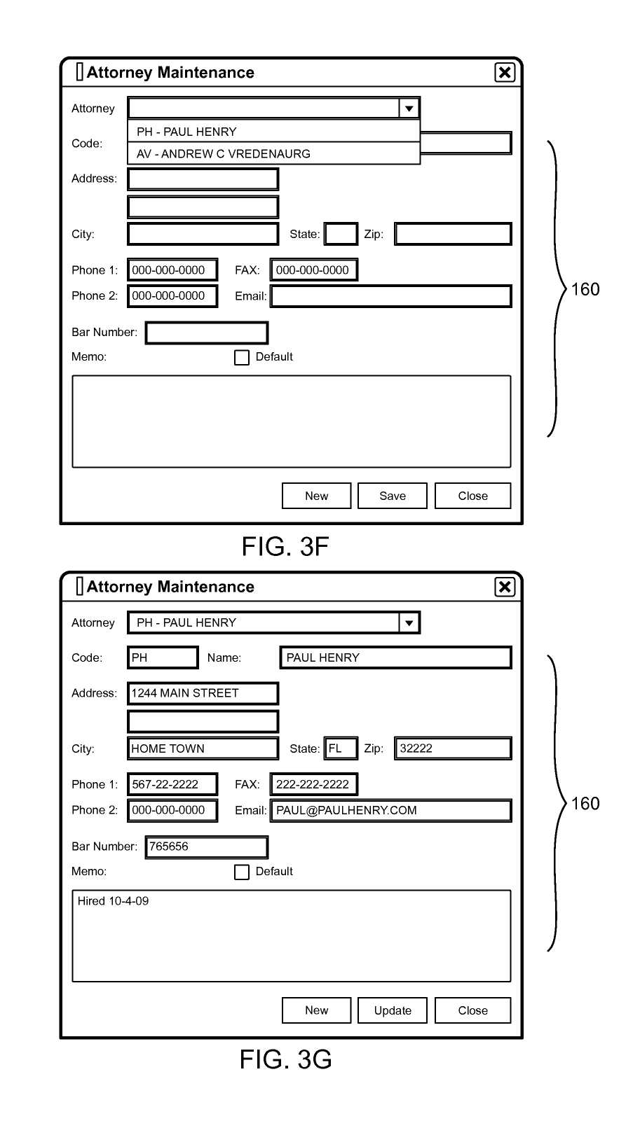

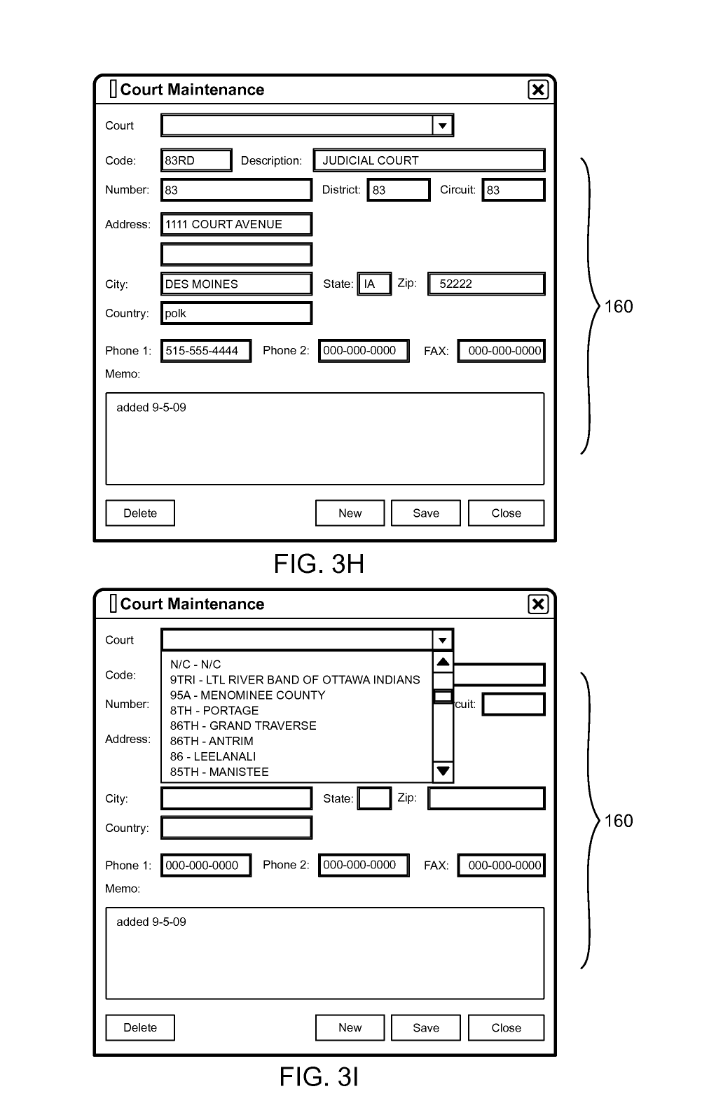

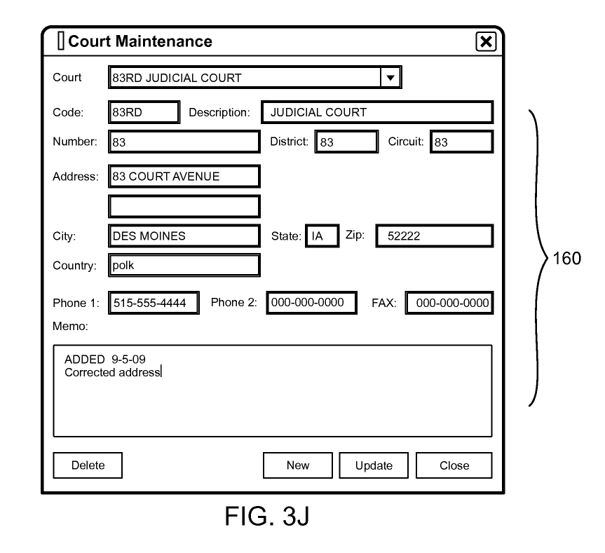

The system 10 imports the loan data as a function. Instructions, which may be in the form of MySQL coding clear to those skilled in the computer science art, pull in the data. Depending on the source, may or may not be transformed, modified, cleansed, or re-formatted, taking into consideration display purposes and ease of user reading. Alternatively, the vehicle dealer or other user 120, at a computer 130 or other specially-programmed processor and using a computer input device, for example a mouse or keyboard employed for interaction with the system 10, may manually enter loan, co-debtor, and other account data pursuant to display prompting and options, as shown in FIGS. 3a-3d. As input is entered into the available fields, like with all text boxes in the system 10, the data is stored in memory on the user's computer 130 as a machine-readable data string representing the pertinent vehicle loan information.

As may be seen in FIGS. 3a-3d, in one embodiment, the display viewed by the user 120 on his or her computer 130 or other specially-programmed processor positions the input translation module 30 under an Origination tab 140. Under this Origination tab 140 is information pertaining to vehicle 35 loans as it comes over from a database management system, for example Auto Master System, Inc.'s auto loan servicing database software sold under the trademark AMS2000.

To this end as well, the option styled Accounting under the Utilities tab 150 which allows a user to import electronic accounting journal entries from third-party business accounting software, for example accounting software sold under the trademark QUICKBOOKS, by Intuit Inc. of Mountain View, Calif.

Also under the Utilities tab 150 in one embodiment of the system 10, the various options and drop-down menus, as may be seen in FIGS. 3e-3j, allow for the entry and configuration of data 160 about the retained attorneys and courts 25 in which matters are pending as well as specific user company information, for example address and Federal Employer Identification number, may be entered and configured.

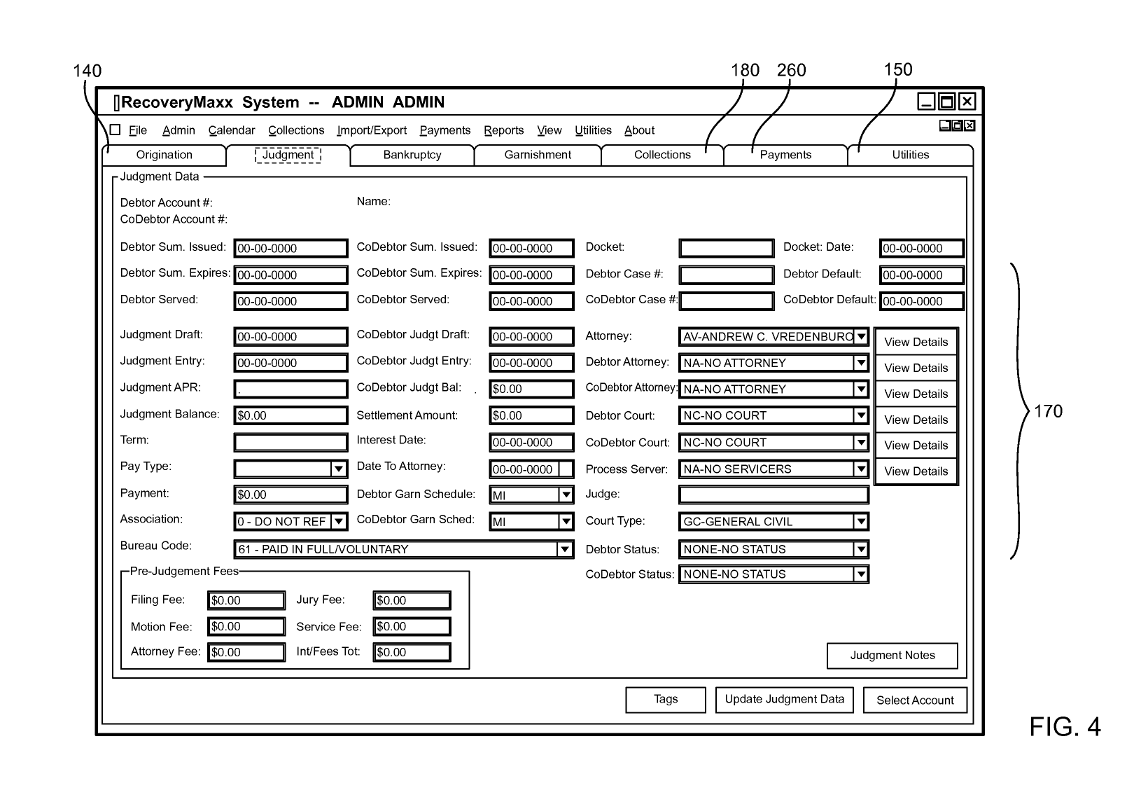

The system 10, through the judgment module 40, also has the ability to track and integrate copious amounts of judgment details 170, which was previously done by hand or with the aid of a standalone and typically manual entry spreadsheets, for example using spreadsheet software sold under the trademark EXCEL by Microsoft Corporation of Redmond, Wash. Available details may vary from case-to-case, but could relate to the case and docket number, judgment date and balance, the issuing court, debtors, co-debtors, counsel retained by debtors, payments, and interest. Such details may be entered by the user through a series of selections from among various predetermined attributes or customized entry of text and other data relevant to the user's particular debt collection process and status. FIG. 4 depicts a example user's computer 130 display while judgment details 170 and notes are being reviewed and/or entered.

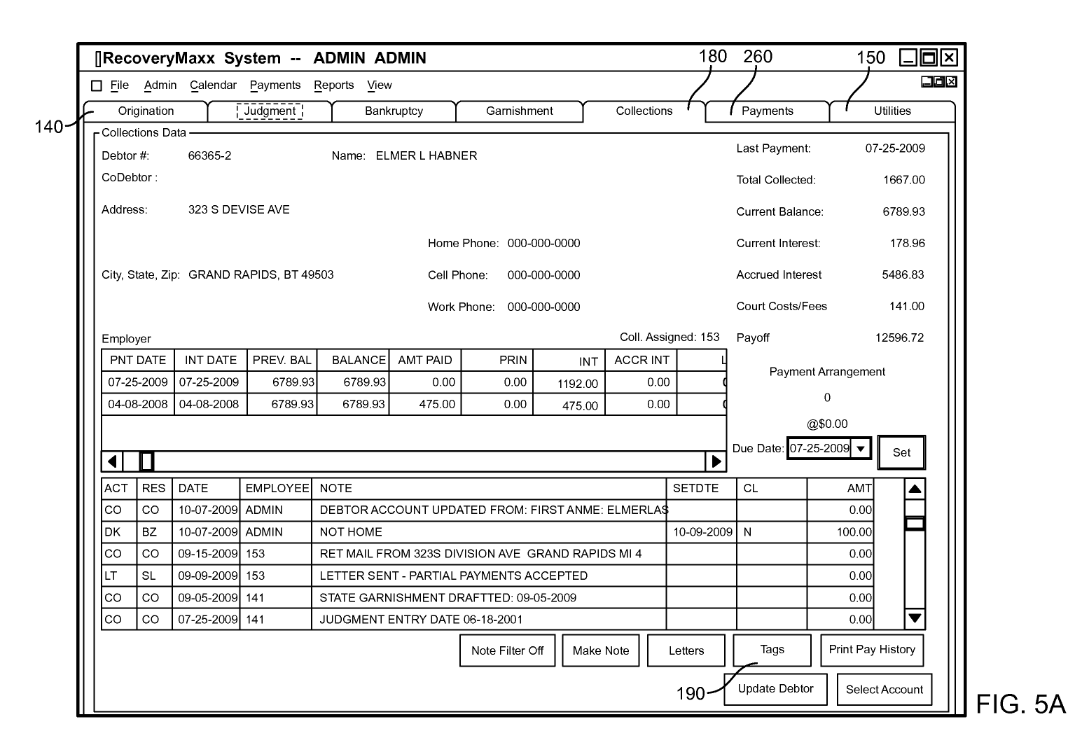

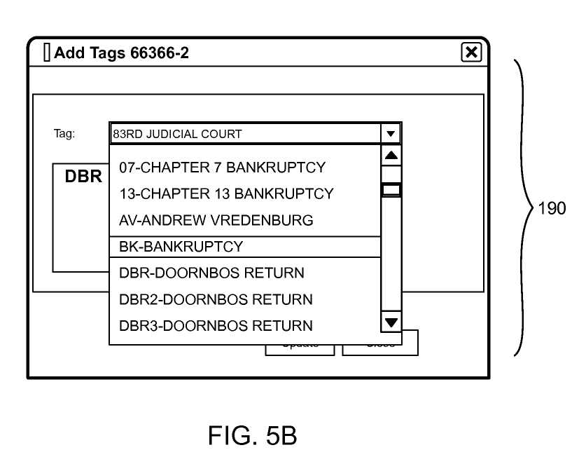

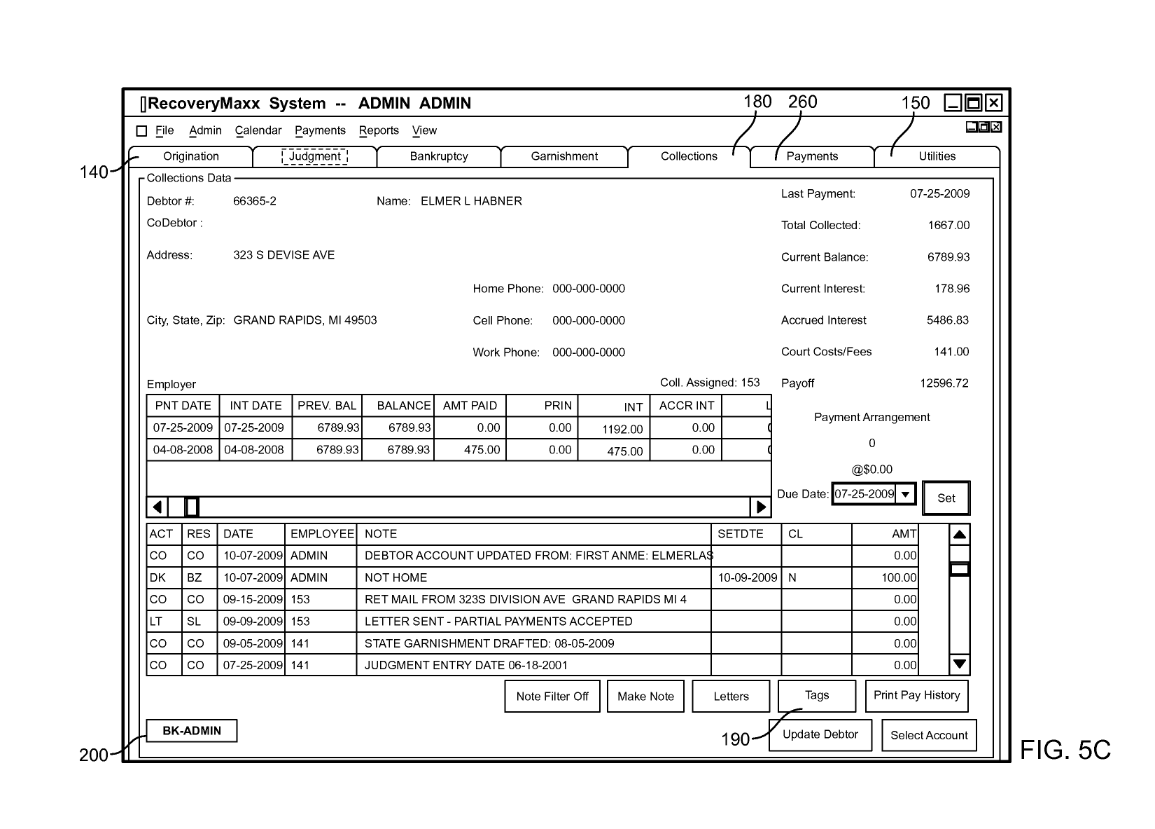

The tracking module 80, illustrated in FIGS. 5a-5c, allows the user to create and manage a select subset of data from among that stored in the database 20, essentially by earmarking accounts for any of various reasons through a tagging mechanism.

Found under the Collections tab 180 on a user's computer 130 display in an illustrative embodiment, all sorts of tags 190 are available to allow the user 120 to earmark an account. The tagging is table-driven, and a user 120 in one embodiment may be given the capability to add to the table and thus create his or her own tags 190, with any sort of tag 190 then being possible.

Conceivably, tags 190 may relate to any desired attribute, including, for example, the legal status of a case against a first party (debtor or co-debtor) (for example, using BK to represent bankruptcy, as in FIG. 5b); serve as indicators for noteworthy issues, for example small claims status, state tax garnishment, settlement possibilities, the identity of the attorney representing the debtor, the identities of co-debtors or the account owner (if the loan is being serviced by another company); payment by check not allowed, payment by ACH not allowed, no employment, new employment, or simply to flag an account for manager review. The ability of a user to add or remove a tag may be limited based on a level associated with a specific type of tag and the authorization granted to a particular user, for example, based on whether the user is a supervisor or not.

Moreover, under the Utilities tab 150 in one embodiment, the Table Maintenance option allows a plurality of “warning levels” for tags 190, one or more of which may dictate that a pop-box notification will always appear in connection with a certain account and another or none of which may prevent pre-selected actions associated with the account.

Entered tags 190 will be exceptionally visible on the user's computer 130 screen displays for that account, for example in a highlighted or colored warning area 200 at the bottom left of the window, as shown in FIG. 5c. A user 120 can truly “slice and dice” the data and generate reports based on the tags 190 which have been entered, and removal of previously-entered tags 190 may be accomplished with a minimal number of mouse clicks or other input from the user 120, or automatically upon a subsequent event entry or activity. Tags may also be used as a filter to select, exclude, order, or otherwise access and/or batch process or queue a subset of accounts.

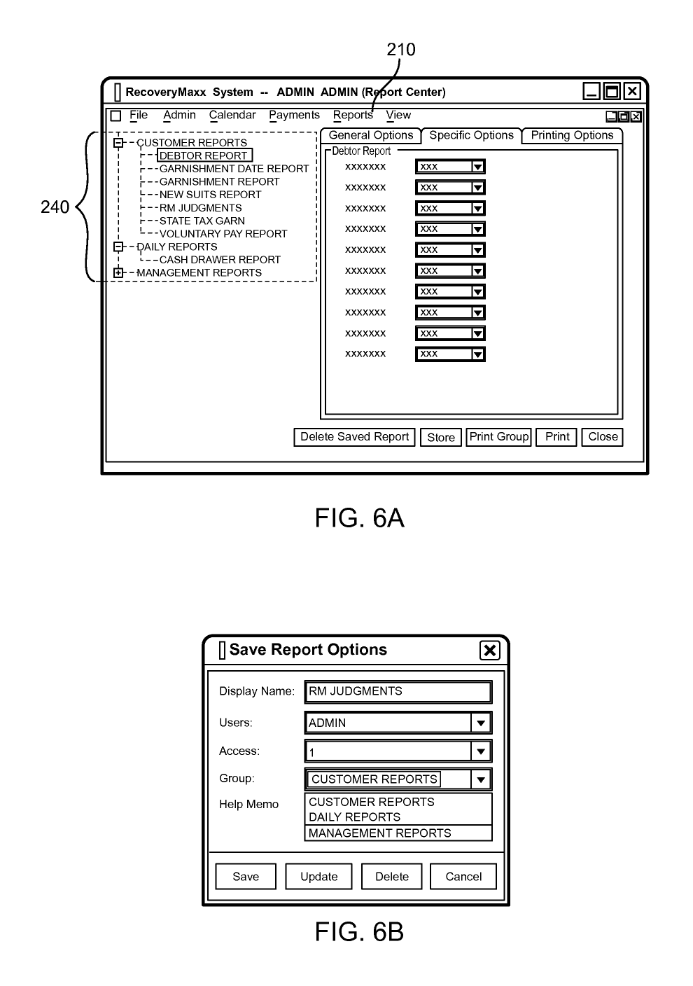

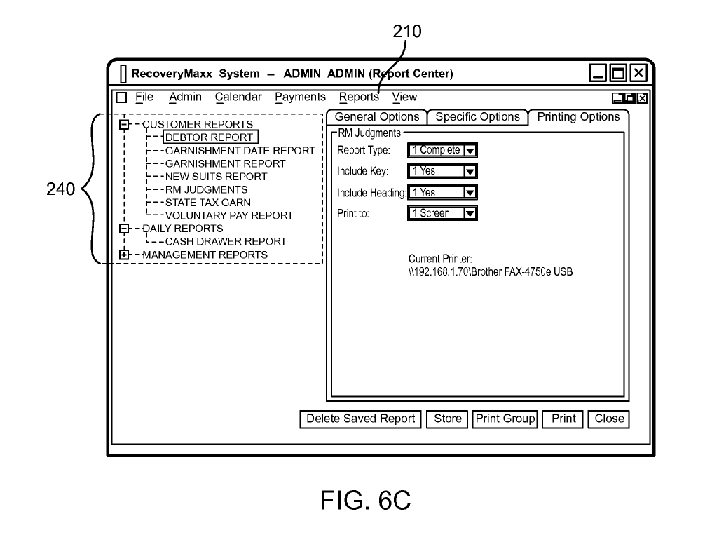

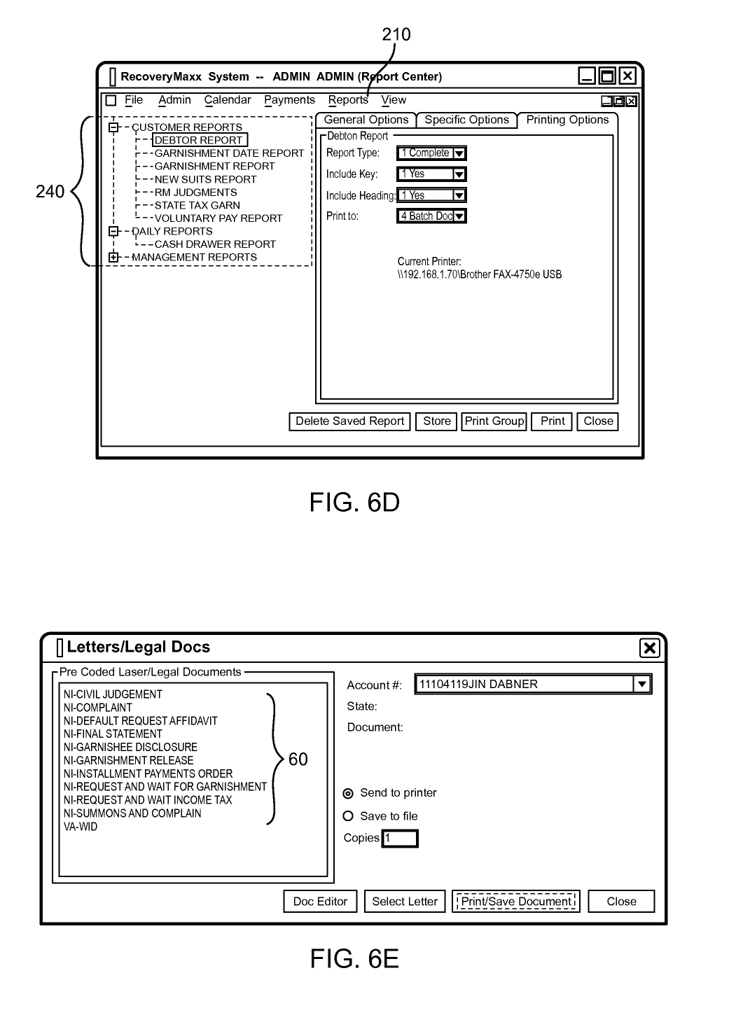

Shown in FIGS. 6a-6e, the queuing module 100 provides a way for the user 120 to retrieve and navigate through a group or pool of accounts, rather than individually, based on some criteria. More specifically, the queuing module 100, for example found under the Reports heading 210 in an illustrative embodiment, is a feature which interacts with the garnishment module 50, other system 10 elements, and the database 20, and allows guided navigation through the selected group of accounts and batch processing of documents and efficient generation of a wide variety of customer and management reports, complaints, garnishment requests, and other hard-copy documentation 60. Navigation through a selected subset of accounts can be guided by a series of on-screen buttons appearing on the display of the user's computer 130. For example, the queuing module can be used to develop a subset of accounts for which a particular user is assigned to make collection calls to.

The batch processing feature will complete legal forms 60, for example a complaint or request to obtain a judgment or for a garnishment. Also advantageously, batch application of the required fees and costs, filing and otherwise, are among the options provided by the queuing module 100 both to be paid and to be added to the amount due on the account. The batch processing can include auto filing of preformatted forms based on the subset of accounts and in accordance with an applicable jurisdiction's requirements. For example, the batch processing can provide a set of electronic or paper documents that only need be reviewed and/or signed before filing with a court, employer, or other agency.

The time efficiency and deadline oriented basis of these features will prove particularly beneficial to a high-volume automobile dealer 120, service provider, or other financier facing deadlines for many garnishments or other actions set to expire and consequently need to be re-filed, or facing statute of limitation deadlines for filing for many judgments. For example, batch processing of a subset of accounts having garnishment “expirations” (which happens in at least some jurisdictions every ninety-one (91) days) facilitates the generation of legal complaints 60 for each account having an expiration within a specified upcoming date range. The only further action required after batch production of documents would be the review or addition of the signature of the creditor's attorney. Similarly, other subsets of accounts can be selected and batch processed based on specifying a different action and associated range of dates for the deadline, including but not limited to filing to obtain a judgment and employer certification of a garnishment.

The required state garnishment forms are entered into the system 10 by download from a governmental agency or court 25 through a connection to the Internet 220 or other wide-area or local network, the system 10 automatically looks out for updates to the required state garnishment forms. These forms typically will come in the Portable Document Format (PDF) created by Adobe Systems Incorporated.

The user 120 has the option of printing reports in the PDF format, suitable for immediate filing given any needed execution by an attorney or other representative, or outputting them through a printer 230 hard-wired or wirelessly connected to the user's computer 130 or other processor. The printer 230 will be commercial-grade in some embodiments and capable of high-volume and high-speed output.

The full array of report formats, which can include those created by a user, are stored in a tree hierarchy 240 (visible on the left side of the window in FIGS. 6a, 6c, and 6d) and, as indicated, may be printed as a group. It is envisioned that the queuing module 100 includes the ability to generate a worklist of accounts, based on criteria, for example location or the company owning the vehicle loan deal. This will be much more efficient, allowing the user 120 to avoid individually selecting customers whose accounts need processing.

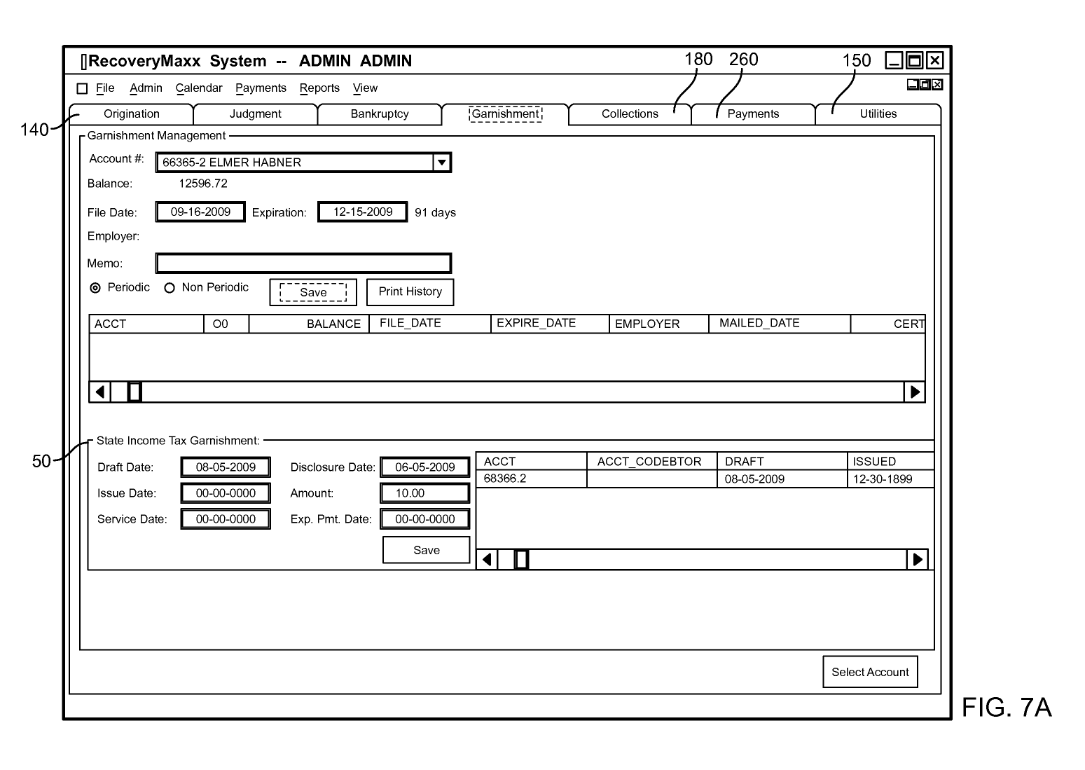

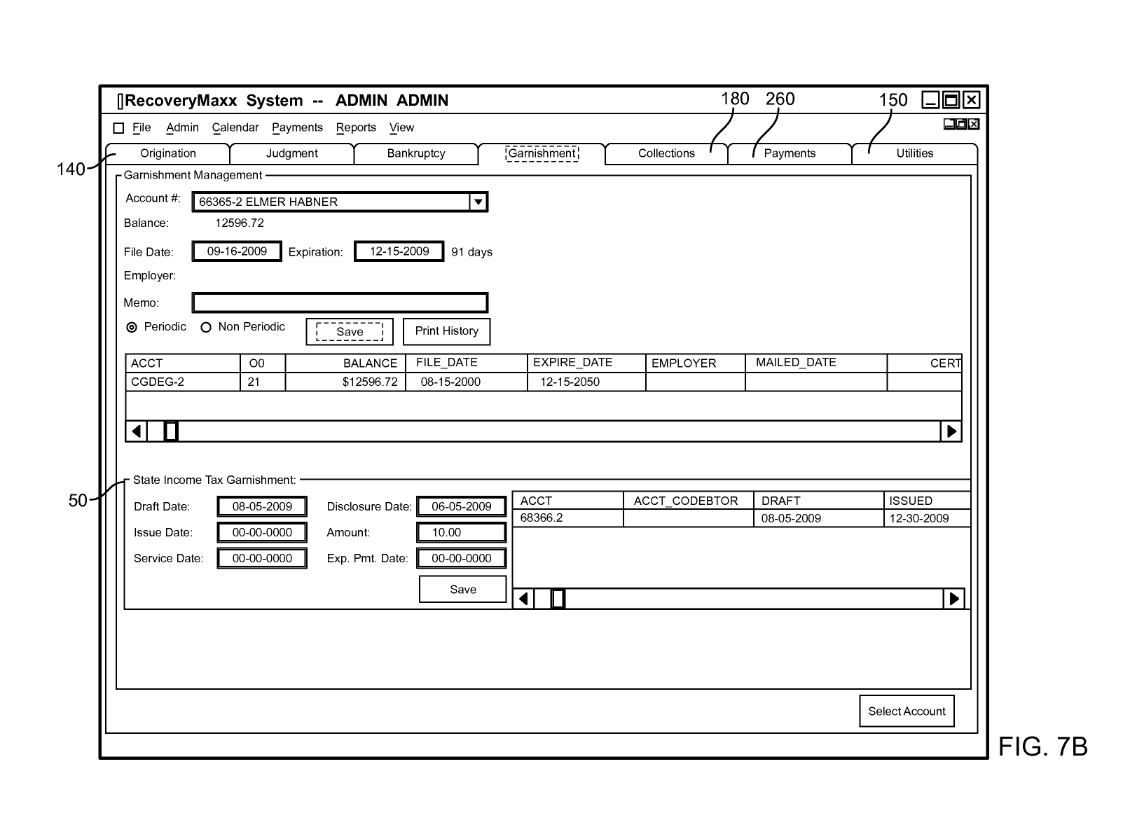

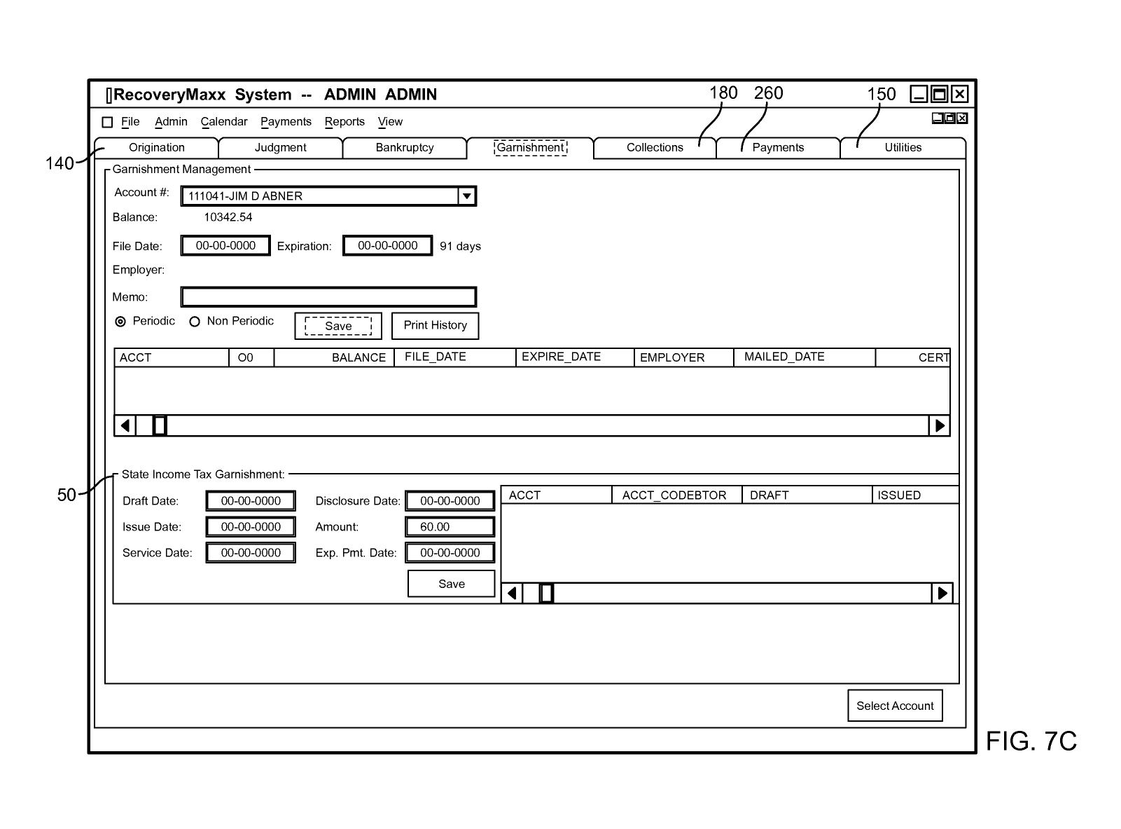

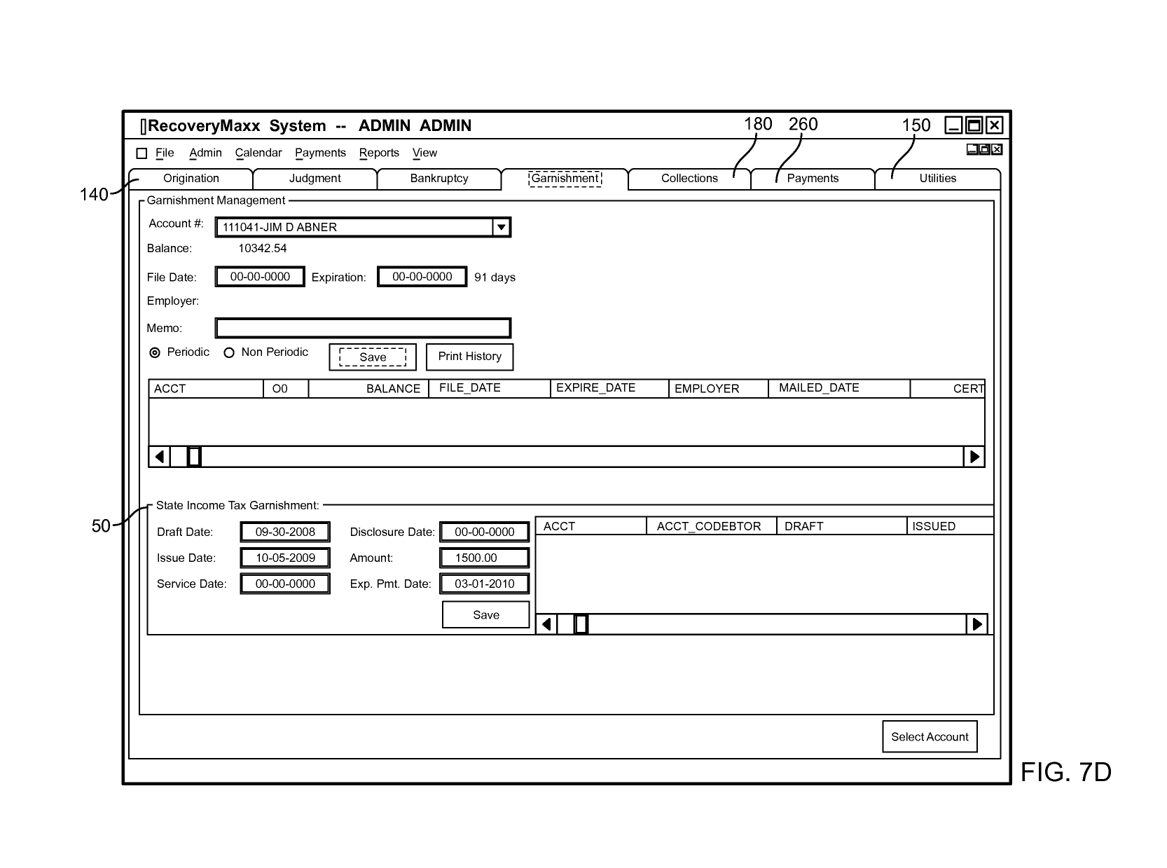

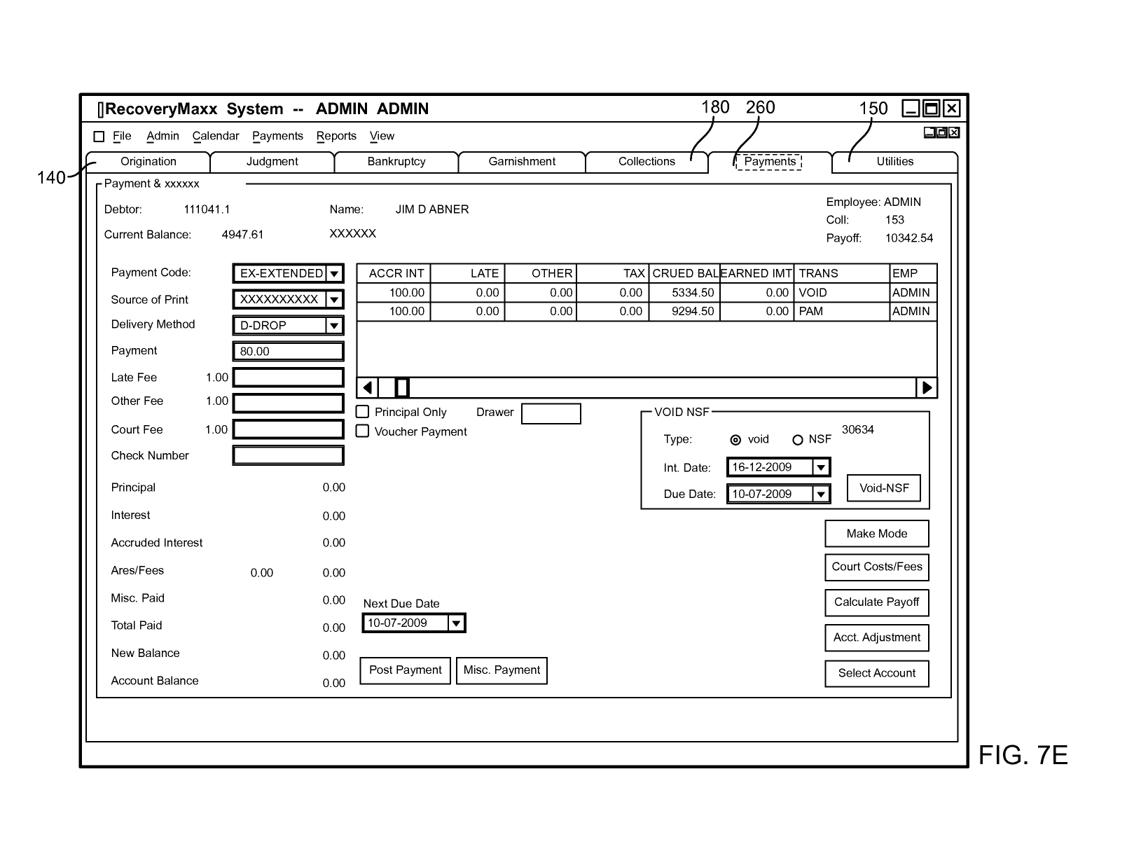

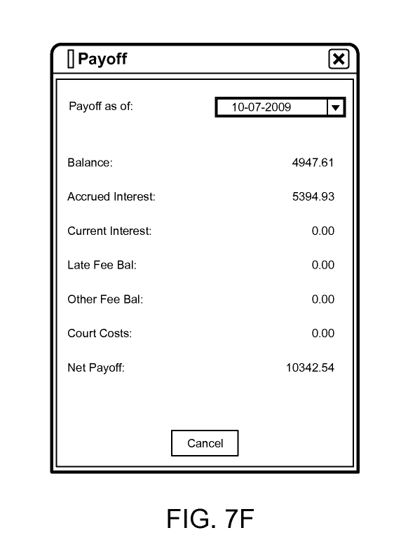

The garnishment modules 50 and 70 are represented in FIGS. 7a-7f. There are at least two types of garnishment in states in the United States which allow such means of collecting a monetary judgment: (1) standard wage garnishment, which requires very close tracking of the garnishment expiration date, and (2) state income tax garnishment (in states, for example Michigan and Oklahoma), whereby a creditor may obtain a portion of the debtor's forthcoming tax refund. Both the tax garnishment module 50 and the wage garnishment module 70 involve coding, understood by those skilled in the art, to implement complex interest-bearing calculations using the annual percentage rate (APR) and balances of selected accounts in the database 20. These automated calculations, illustrated in FIGS. 7e and 7f, allow efficient administration of a plurality of wage and/or state tax garnishment efforts being made by a user 120 of the system 10.

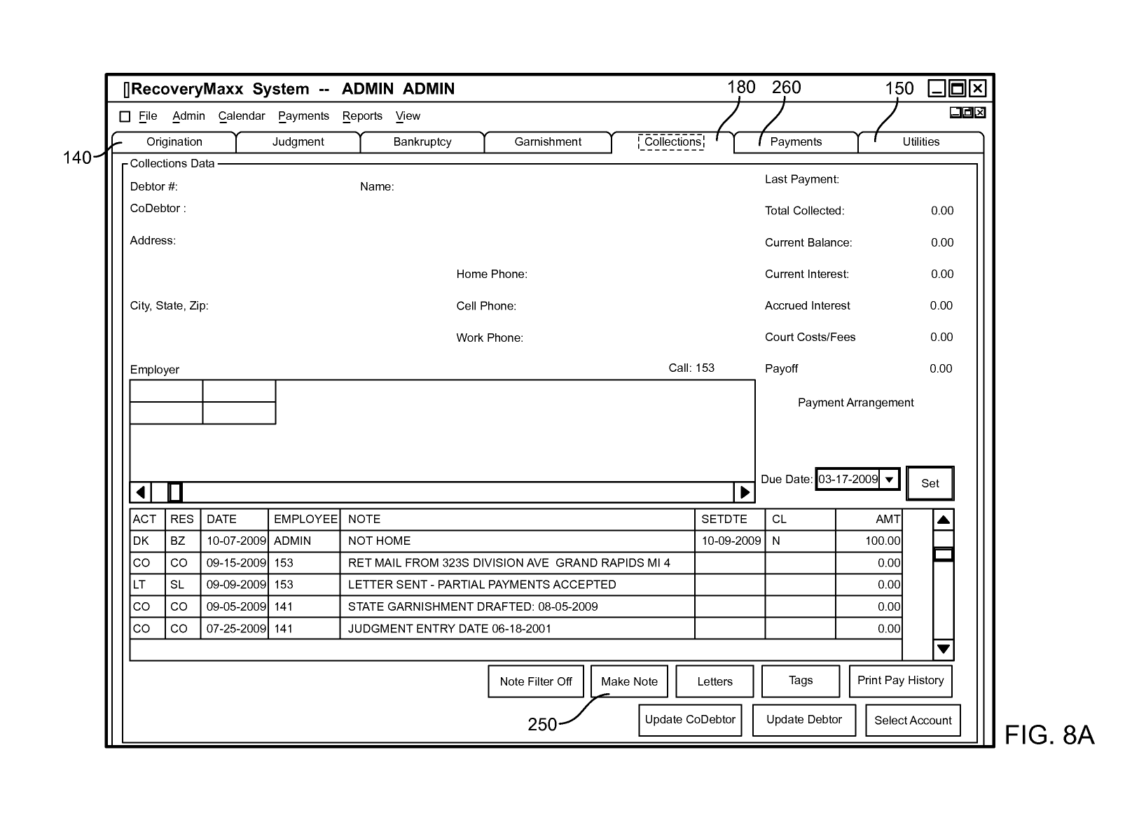

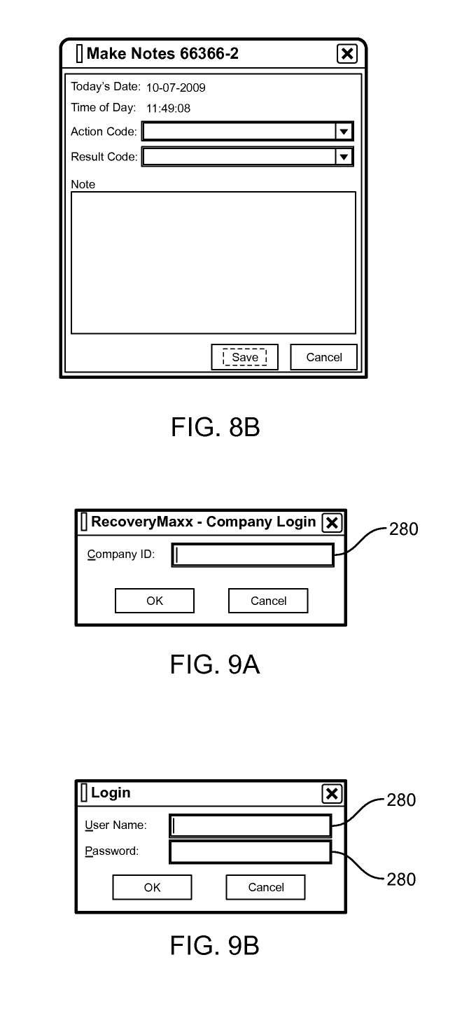

The illustrative system 10, through action module 90, has its own built-in calendar feature, whereby garnishment events may be entered, annotated, and shared with desired individuals within the company using the system. The annotation option 250 is shown toward the bottom of the window in FIG. 8a, while FIG. 8b represents an exemplar note form ready for input. Particular notes can be marked to stick to the top level so that they are easily visible and not missed when a user access that particular account. Important dates and deadlines may be automatically entered in one embodiment. Appointment scheduling, with attachment of electronic documents thereto, is possible in one embodiment.

Whether an automobile dealer or other service provider, a user 120 of the system 10 will usually desire to have some sort of record any time contact is made with a debtor or co-debtor or another action or status change arises. Within the auspices of the action module 90, note entry, an option under the Collections tab 180 in one embodiment, is possible for events, for example a debtor's promise to pay, and codes may be assigned thereto by the user for quick, batch processing as well as the sorting of entered notes. The manual updating of a number of data fields, for example contact or employment information, concerning specific debtors or co-debtors may also be an option under the Collections tab 180 or elsewhere among the elements of the system 10.

Through options and drop-down menus under the Payments tab 260 in one embodiment, monies received from debtors or co-debtors or expenses incurred by the user 120 in the form of court 25 costs may be recorded. The amount owed includes a debt, for example, the principal amount can be a deficiency on an account after repossession and crediting for an amount obtained from an auction or other resale of the vehicle. The amount owed can also include other monies due on the account in addition to the principal amount, for example, interest, attorney fees, court fees, other fees, and taxes. The ability provided to break down, if necessary, the payments into these and other types of amounts owed is available in an illustrative embodiment, as is the ability to calculate a payoff balance as of a date selected by the user.

The output translation module 110 in one embodiment provides the user with the capability to transform a portion or all of the data set of accounts, for example, for use with third-party accounting and/or financial analysis systems, the original database management system from which the input translation module 30 data was taken, or other systems, including electronic filings with courts and other agencies, including reporting data regarding particular accounts to a credit reporting bureaus.

The system 10 in one embodiment includes software developed in a common high level programming language for operation in an individual processor and a networked server environment. Preferably, a Web application software format is utilized for platform independence; such an application is accessed and executed via a common Web browser over a network, for example the Internet 220 or an intranet. Coding may be in a browser-supported language, for example JavaScript and combined with a browser-rendered markup language like HyperText Markup Language (HTML). When implemented over the Internet 220, the system 10 is compatible with the increasingly-popular Software as a Service model (SaaS).

In the illustrated embodiment, the user 120 communicates by computer 130 or other processor with a server computer, which may actually be multiple interconnected server computers comprising routes of the Internet 220. The server computers of the Internet 220 are capable of electronically communicating with a Web site hosting computer 270, which can include input devices, for example a keyboard or mouse and possibly a printer or other output devices, including devices that transform some tangible object.

A collection of individual Web pages, a Web site is created and populated with content by methods known to those skilled in the computer science art, including, but not limited to, the formatting instructions of Hypertext Markup Language (HTML) or Extensible Hypertext Markup Language (XHTML). Inter-linked, hypertext software allows for forward or backward movement through the various system 10 modules and method 500 steps, and icons and a browser tool bar may be utilized by the user to navigate among the pages on the Web site.

More specifically, in the illustrative embodiment, the Web site is hosted by a computer 270 or other processor, which is capable of resource-intensive data intake and processing, or, alternatively, in communication with a separate, back-end data-processing computer (not shown) administratively configured. The Web site is programmed to be highly interactive and capable of accessing the database 20 as shown in FIG. 1.

Hardware and/or software-based firewalls preferably are used to block unauthorized access to the system 10, based upon a set of rules and other criteria known to those skilled in the computer science art, while permitting authorized communications through the system. Applicable firewall techniques include filtering of each packet passing through the network, application or circuit-level gateway checks at the time of connection, and proxy server interception.

Also for security purposes, in the illustrative embodiment, as seen in FIGS. 9a and 9b, the user can be required to log in to the system 10 by entering into one or more text input boxes 280 standard identifying information, including name or e-mail addresses and a password. In lieu of name or e-mail address, a specific company number may be used for identification purposes and to determine where a given company's data set is stored.

In addition, due to the broadband capabilities of modern electronic network technology, more than one user 120 may access the system 10 at any given time. It is moreover envisioned that the extent of processor control over the modules of the system 10 may vary from an entirely-automated system to one which is controlled only in part by machine.

The illustrative embodiment of the claimed system 10 is implemented, in part, over the Internet 220, but, in the alternative, may be practiced on any wide-area or local electronic network. It will be understood by those having skill in the art of computer networks that the system 10 may include more or fewer computers, nodes, or processors than those described or depicted herein.

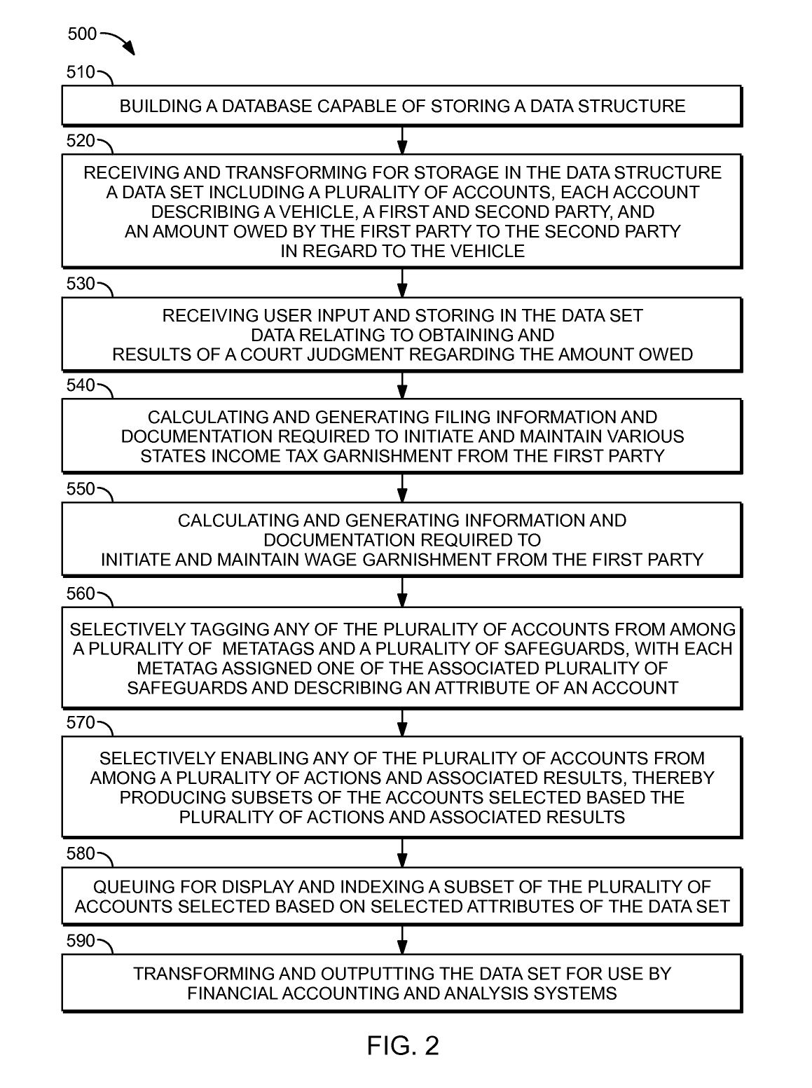

Referring to FIG. 2, a method 500 for vehicle account collection is shown as a flowchart of certain of the steps for implementation thereof. Arrows represent the flow of an electronic signal embodying information. The steps of the method 500 may be executed in part or in their entirety by hardware, for example a computer or other specially-programmed or equipped processor. Required and optional modules, the data set, and the outputted reports and other documents are quite similar to those discussed above relating to the system 10, and the above descriptions of same are specifically incorporated by reference.

The method 500 may commence with a step 510 wherein a database 20 is built, by an authorized user 120, that is capable of storing a data structure. Being table-driven, the method 500 follows the relational database schema for efficient data processing.

At steps 520 and 530, a data set is received and transformed for storage in the data structure. These steps 520 and 530 entail the receipt of input from a user 120, at a computer 130 or other specially-programmed processor and using a computer input device, for example a mouse or keyboard employed for all interaction with the particular system implementing the method 500, data relating to obtaining and results of a court 25 judgment regarding the amount owed. This data is, in turn, stored in the data set. The data set will include information as to a plurality of vehicle 35 loan accounts, with each account at least describing a vehicle 35, a first and second party, and an amount owed by the first party to the second party in regard to the vehicle 35. Once such input is entered, be it as an automated import through MySQL coding or done manually by the user 120 (FIGS. 3a and 3b), the data is stored in memory on the user's computer 130 or other specially-programmed processor, a computer 270 or other processor hosting a Web site, or a back-end data-processing computer as a machine-readable data string representing the pertinent vehicle 35 loan information.

Step 540 involves the automated calculation and generation of filing information and hard-copy documentation 60 required to initiate and maintain various states' income tax garnishment from the first party, namely the vehicle 35 purchaser in one embodiment. Representative computer screen shots are found in FIGS. 7c and 7d. Similarly, step 550 involves the automated calculation and generation of filing information and hard-copy documentation required 60 to initiate and maintain wage garnishment from the first party. As may be ascertained from FIGS. 7e and 7f, the calculations in these steps may require computer programming, understood by those skilled in the art, to implement complex interest-bearing calculations using the annual percentage rate (APR). The physical documents 60 may be output on a standard computer printer 230 in hard-wired or wireless communication with the user's computer 130 or other programmed processor.

Illustrated in FIGS. 5a-5c, selectively tagging any of the plurality of accounts in the database from among a plurality of metatags 190 and a plurality of safeguards makes up step 560. Each metatag 190 is assigned, by the user, one of the associated plurality of safeguards and describes an attribute of an account in the database data set. The wide array of metatags 190 may be in the form of predetermined attributes, as seen in FIG. 5b, to reflect concepts, for example the type of bankruptcy declared in a given account or the closed status of a given account, or may be customized earmarks created and entered by the user 120. The step 560 allows for “warning levels” to be assigned with the tags, obliging the user 120, or others designated by the user 120, to approve or otherwise acknowledge information and/or the status of selected accounts, or for prevention of a user-selected action.

At step 570, the user's selective enabling any of the plurality of accounts from among a plurality of actions and associated results will produce a useful subset of the accounts selected based on the plurality of actions and associated results. Specifically, this selection of accounts in the database 20 can create an effective and manageable worklist of vehicle 35 loan accounts requiring attention to one degree or another. The present invention also allows for annotations to reflect important events, for example a debtor or co-debtor's promise to make a payment, or deadlines for actions, for example a court filing.

The queuing at step 580 consists of the generation, for display, indexing, and navigating a subset of the plurality of accounts selected based on selected attributes of the data set. Representative screen shots are found in FIGS. 6a-6e. Actions on each navigated-to member of the subset can be manually applied or, alternatively, automated actions applied to the entire subset. For example, applying account information stored in the database 20 to previously-downloaded court 25 and other governmental forms, this step 580 can yield any of a variety of useful reports selected by the user 120 as well as automatically complete garnishment forms stored in the database. The completed forms 60 may be legal complaints or garnishment requests and merely need execution for court filing once hard-copies 60 are produced with the aid of a hard-wired or wirelessly-connected printer 230. In the alternative, the forms and reports may be produced in the popular PDF electronic file format. Reports generated by queuing can be saved in a tree hierarchy for ease of reference in one illustrative embodiment.

Step 590, the final step, allows for the transforming and outputting of the data set, for example, for use by certain third-party accounting and/or financial analysis systems.

In more technical detail, the illustrative method 500 begins with a user 120 utilizing a computer 130 or other specially-programmed processor equipped with an input device, Web browser software, and user interface, to access the Internet 220 or another wide-area electronic network which is capable of communicating with a hyperlinked Web site, by virtue of a signal running through at least one server computer. For example, the signal can be transported through the Hypertext Transfer Protocol (HTTP), which may employ encryption to provide security and privacy for the consumer. Devices, for example hardware and/or software-based firewalls can be used to block unauthorized access to the system 10 implementing the method 500, based upon chosen rules and other criteria, while permitting authorized communications through the system.

Alternatively, the disclosed system 10 and method 500 could be directed to the garnishment of bad debts on tangible or non-tangible objects besides vehicles 35, and some system and/or method outputs might relate to the disposition of a vehicle 35 before it is sold at auction, for example the pursuit and issuance of liens and repossession attempts.

It should be understood that the illustrated steps can only be partially represented by computer screen images and are merely exemplary of one embodiment. Other steps may be added, some may be omitted, and some may be performed without a computer or other processor. Furthermore, variations in the step sequence are certainly envisioned, and the order of the steps may be changed for particular types of loans, debt collection processes, or physical objects to which the loans relate.

While the invention has been illustrated and described in detail in the foregoing drawings and description, the same is to be considered as illustrative and not restrictive in character, it being understood that only illustrative embodiments thereof have been shown and described and that all changes and modifications which are within the scope of the claimed subject matter are desired to be protected.

1. A system for vehicle debt recovery, comprising:
a database for storing a data structure;
a data set stored in the data structure and including a plurality of accounts;
at least a first and second party associated with each of the plurality of accounts;
a vehicle associated with each of the plurality of accounts;
a processor;
software specially programming the processor, the software including an action module providing a plurality of actions and enabling selectively associating the plurality of actions with each of the plurality of accounts; and
a deadline associated with at least one of the plurality of actions for each of the associated plurality of accounts; and
wherein:
each of the plurality of accounts describe an amount owed by the first party to the second party in regard to the vehicle;
the at least one of the plurality of actions includes a legal filing associated with the account; and
the software enables subsets of the plurality of accounts to be selected based on the associated at least one of the plurality of actions and the associated deadline.

2. The system of claim 1, wherein the software further enables batch processing of the legal filings for the selected subset of accounts.

3. The system of claim 2, wherein the legal filings comprise electronic or paper documents.

4. The system of claim 3, wherein:
the software further includes a tax garnishment module;
the legal filings relate to initiating or maintaining a tax garnishment against the first party for each of the subset of accounts; and
the tax garnishment module enables populating the legal filing for each of the subset of accounts in accordance with a particular jurisdictions's requirements.

5. The system of claim 3, wherein:
the software further includes a wage garnishment module;
the legal filings relate to initiating or maintaining a wage garnishment against the first party for each of the subset of accounts; and
the wage garnishment module enables populating the legal filing for each of the subset of accounts in accordance with a particular jurisdictions's requirements.

6. The system of claim 3, wherein:
the software further includes a judgment module;
the legal filings relate to initiating or obtaining a judgment against the first party for each of the subset of accounts; and
the judgment module enables populating the legal filing for each of the subset of accounts in accordance with a particular jurisdictions's requirements.

7. The system of claim 2, further comprising a selected range of dates and wherein the subset of accounts is selected based on the associated deadlines for the at least one of the plurality of actions falling within the selected range of dates.

8. The system of claim 2, wherein the software further includes an input translation module enabled to receive data from another system and transform the data for storage in the data structure, the data relating to the plurality of accounts.

9. The system of claim 2, wherein the software further includes an output translation module enabled to transform a portion of the data set for receipt by another system, the data relating to the plurality of accounts.

10. The system of claim 2, wherein the software further includes a tracking module providing a plurality of metatags and a plurality of safeguards and enabling selective association of the plurality of metatags with each of the plurality of accounts, each metatag assigned one of the associated plurality of safeguards and describing an attribute of an account, selective ones of the plurality of safeguards providing warnings or preventing selected actions for the account for which the metatag and safeguard is associated.

11. The system of claim 2, wherein the software further includes a queuing module allowing display and indexing through a subset of the plurality of accounts selected based on selected attributes of the data set.

12. The system of claim 11, wherein at least one of the selected attributes is the deadlines.

13. A method for vehicle debt recovery, comprising the steps of:
providing a database for storing a data structure
receiving and transforming for storage in the data structure a data set including a plurality of accounts, each account describing a vehicle, a first and second party, and an amount owed by the first party to the second party in regard to a vehicle;
selectively associating at least one of a plurality of actions with each of the plurality of accounts, the at least one of the plurality of actions including a legal filing associated with the amount owed;
calculating a deadline associated with the at least one of the plurality of actions for each of the plurality of accounts; and
selecting a subset of the plurality of accounts based on the associated at least one of the plurality of actions and the associated deadline.

14. The method of claim 13, further comprising the step of processing a batch of legal filings for the selected subset of accounts.

15. The method of claim 14, wherein the legal filings relate to initiating or maintaining a garnishment against the first party for each of the selected subset of accounts, and the method further comprises the step of populating the legal filing for the selected subset of accounts in accordance with a particular jurisdictions's requirements.

16. The method of claim 14, wherein the legal filing relates to initiating or obtaining a judgment against the first party for each of the selected subset of accounts, and the method further comprises the step of populating the legal filing for the selected subset of accounts in accordance with a particular jurisdictions's requirements.

17. The method of claim 13, further comprising the step of selecting a range of dates and wherein the subset of accounts is selected based on the associated deadlines for the at least one of the plurality of actions falling within the selected range of dates.

18. The method of claim 13, further comprising the step of selectively tagging any of the plurality of accounts from among a plurality of metatags and a plurality of safeguards, with each metatag assigned one of the associated plurality of safeguards and describing an attribute of an account, selective ones of the plurality of safeguards providing warnings or preventing selected actions for the account for which the metatag and safeguard is associated.

19. The system of claim 13, further comprising the step of queuing for display and indexing a subset of the plurality of accounts selected based on selected attributes of the data set.

20. A system for debt recovery, comprising:
a database for storing a data structure;
a data set stored in the data structure and including a plurality of accounts;
at least a first and second party associated with each of the plurality of accounts;
a processor; and
software specially programming the processor, the software including an action module providing a plurality of actions and enabling selectively associating the plurality of actions with each of the plurality of accounts; and
wherein:
each of the plurality of accounts describe an amount owed by the first party to the second party;
the at least one of the plurality of actions includes a legal filing associated with the amount owed; and
the software enables subsets of the plurality of accounts to be selected based on the associated at least one of the plurality of actions.
